(19) United States
(12) Patent Application Publication
(10) Pub. No.: US 2024/0101855 A1
(43) Pub. Date: Mar. 28, 2024

(54) Coated Article

(71) Applicant: Dow Global Technologies LLC, Midland, MI (US)

(72) Inventors: Manesh Nadupparambil Sekharan, Lake Jackson, TX (US); Yinzhong Guo, Lake Jackson, TX (US); Lawrence J. Effler, Jr., Freeport, TX (US); Sudhanwa D. Dewasthale, Lake Jackson, TX (US); Christopher I. Gandy, Houston, TX (US)

(21) Appl. No.: 18/254,163

(22) PCT Filed: Nov. 9, 2021
(86) PCT No.: PCT/US2021/058618

§ 371 Date: May 23, 2023

Related U.S. Application Data
(60) Provisional application No. 63/122,686, filed on Dec. 8, 2020.

(51) Int. Cl. C09D 133/08; B05D 5/02; B05D 7/04; B29B 17/04; C08J 7/04

(52) U.S. Cl. CPC C09D 133/08; B05D 5/02; B05D 7/04; B29B 17/0412; C08J 7/0427; B05D 2201/02; B05D 2502/005; C08J 2333/08

(57) ABSTRACT

A coated article having recyclability properties including a combination of: (a) at least one polyolefin polymer article; and (b) a coating layer of a waterborne acrylic-based matte coating composition having a recyclability property, wherein the recyclability property of the waterborne acrylic-based matte coating composition is such that when the article with the waterborne acrylic-based matte coating composition is reprocessed, the article with the waterborne acrylic-based matte coating composition exhibits at least less than a 30% decreased change in performance compared to a control article without the waterborne acrylic-based matte coating composition; wherein both the control article and the article with the waterborne acrylic-based matte coating composition are both reprocessed the same way; a recyclable coated film structure including at least: (a) at least one first polymer film layer; and (b) at least one coating layer of the above recyclable waterborne acrylic-based matte coating composition; and a process for manufacturing the above recyclable coated film structure.

### FIELD

The present invention is related to a coated article; and more specifically, the present invention is related to a coated article including a combination of a polyolefin polymer article and a waterborne coating composition having a recyclability property.

### BACKGROUND

Heretofore, the use of plastic products, for example, packaging materials for the packaging industry, has significantly increased globally. Unfortunately, the increase in demand for plastic products has created a significant increase in plastic waste because after a plastic product has been used by the consumer the plastic product is discarded by the consumer; and the plastic waste detrimentally impacts the environment in many countries around the world. To alleviate or reduce the plastic waste problem, manufacturers have attempted to produce a plastic product that can be readily recycled and reprocessed into other subsequent plastic products after the original plastic product has been used for its original purpose. However, the development of a plastic product made from an all-recyclable material has had limited success.

Typically, a plastic product, particularly a coated film structure, is a composite structure made from a combination of various different materials, some which are recyclable and some which are not. For example, the film layer of a coated film can be made of a recyclable material such as polyethylene, but the coating material of the coated film may be made of a non-recyclable material such as a polyurethane-based material. In particular, such coated films coated with an incompatible coating composition makes such coated film difficult to reprocess (i.e., recycle). For example, known coated film structures containing two incompatible component layers cannot be recycled “as is” because the resulting recycled material would perform poorly in the process of manufacturing a subsequent article from the recycled material. Furthermore, because the film substrate layer components are not compatible with each other, if such film structure containing different incompatible substrate materials is desired to be recycled by a converter, the converter is required to separate the film layer from the coating layer before recycling the coated film which makes the recycling process complicated, inefficient, and costly. Such non-recyclable coated film structures are typically discarded as waste which adds to the plastic waste problem described above.

There are various known coated film structures that include a polyolefin film layer, such as a polyethylene film layer coated with a coating composition that provides the film layer with a uniform, matte coating which exhibits good adhesion to the film layer, good abrasion resistance, and good chemical resistance. For example, the coating composition disclosed in U.S. Pat. No. 6,485,837 provides a polyolefin sheet with a coating composition consisting of a polyurethane or polyester, and a polycarbodiimide compound.

U.S. Pat. No. 8,546,491 also discloses coated substrates, such as coated film products and plastic molded products made of polyolefins such as polyethylene and polypropylene. The coating composition applied to the substrate disclosed in U.S. Pat. No. 8,546,491 contains polyolefin-based composite resin spherical particles and the polyolefin-based composite resin spherical particles are obtained by mixing a polyolefin-based resin, water, and an ethylene oxide/propylene oxide copolymer. The resulting mixture provides a coating film that has a matte appearance and a soft feeling; and is scratch resistance.

Although polyethylene itself is known to be recyclable, neither U.S. Pat. No. 6,485,837 nor U.S. Pat. No. 8,546,491 discloses a final coated article that: (1) uses a coating that has a recyclability property; (2) is recyclable as originally manufactured; or (3) meets the criteria of the packaging industry for being recyclable.

In addition, while an article, such as packaging film, made only of polyethylene (PE) may be recyclable, use of a PE only film to make a packaging article such as pouches has its limitations. One such limitation is that the PE only film has a low (e.g., less than [<]130° C.) heat resistance which is typically a lower heat resistance than a composite film made of different polymer film layers. Hence, the seal areas of a PE only film will melt through or distort the quality of the resultant PE film when exposed to hot surfaces, for example, when the PE film is subjected to heat during a heat-sealing operation in a pouch-making process. Due to the low heat resistance of the PE only film, there is a desire to provide a heat resistant coating suitable for coating the surface of a PE only film that will protect/shield the PE film from damage when the PE film is subjected to contact with hot surfaces. However, when a PE only film is combined with a known non-recyclable coating, the coating can detrimentally affect the re-processability (i.e., recyclability) of the original PE only film. Therefore, there is also a desire to provide a heat resistant coating that has a recyclability property for coating a PE film for manufacturing an article (e.g., pouches, packaging materials, and the like) made of all-recyclable materials. An all-recyclable article would provide an environmentally friendly plastic article and minimize plastic waste.

### SUMMARY

The present invention is directed to a matte coated first plastic article, such as a coated PE film or a packaging product made of a coated PE film, with a heat resistant coating that also has a recyclability property. Once the coated first article is made, the coated first article, such as a packaging product, can easily be recycled at the storefront.

In one embodiment; the coated first plastic article comprises a combination of (a) at least one polyolefin polymer article, and (b) a coating layer comprising at least one coating layer of a waterborne acrylic-based matte coating composition having a recyclability property. The waterborne acrylic-based matte coating composition having a recyclability property (herein referred to a “recyclable waterborne acrylic-based matte coating composition” and abbreviated “RWAMC”) of the present invention advantageously is compatible with the polyolefin polymer article, such that the coated first article, after its original use, can be reprocessed (recycled) to form a subsequent second plastic product with sufficient performance properties to be useful as a second plastic article for various applications. Then consequently, disposing the environmentally-friendly coated first plastic article and adding to the global plastic waste can be avoided.

In another embodiment, the present invention is directed to an article including a combination of: (a) at least one polyolefin polymer article such as a polymer article in the form of a film; and (b) at least one coating layer of RWAMC applied to the surface of the film. The RWAMC advantageously has a recyclability property that makes the article re-processable. In some embodiments, the recyclability property of the RWAMC is determined by reprocessing (recycling) the above article having the RWAMC (first article) to form a reprocessed (recycled) article (second article); and then the performance of the recycled article made from the original article with the RWAMC is measured against a control uncoated article, i.e., an article without the RWAMC. The control article is reprocessed the same way as the recycled article. The original article of the present invention (first article) has a recyclability property such that when a recycled article (second article) is made from the original article with the RWAMC, the properties of the original article are imparted to, and maintained by, the recycled article. In a general embodiment, the recycled article exhibits <a 30 percent (%) decreased change in performance compared to the control uncoated article.

In some non-limiting embodiments, the present invention includes a matte coated first article such as pellets; a monolayer film or a multilayer film; a monolayer laminate or a multilayer laminate; a packaging material; a molded product; and the like.

In some embodiments, the present invention includes a subsequent second article made from any one of the above first articles. In some embodiments, the second article can include, for example, pellets; a monolayer film or a multilayer film; a monolayer laminate or a multilayer laminate; a packaging material; a molded product; plastic composites; molded goods; other laminated structures; and industrial films such as shrink films, stretch wrap films, and agricultural films; and the like.

In some embodiments, the present invention includes a process for producing a matte coated first article having a recyclability property comprising contacting together: (a) at least one polyolefin polymer article such as a film; and (b) the above RWAMC on at least a portion of at least one surface of the film.

Advantageously, the first article made by incorporating the above RWAMC can be subjected to a recycling process in accordance with current recyclability guidelines for the packaging industry. For example, utilizing the RWAMC of the present invention, which is an acrylic-based system, in combination with a polymer film structure, such as an all-polyethylene (PE) film such as a high density polyethylene (HDPE) film at 2.25 grams per square meter (gsm), provides a film structure that can be reprocessed to make a new monolayer film with properties that exhibits at least <30% decreased change in performance relative to a control uncoated film that is reprocessed the same without any RWAMC coating added. For example, a laminate structure made with a coating layer of the RWAMC will allow a converter to: (1) mechanically reprocess the laminate structure directly, as a whole, without the need for separation of materials making up the laminate structure such as the individual layers (e.g., PE film and coating) of the laminate; and (2) generate a new film from the reprocessed laminate structure, wherein the new film has a sufficient desirable performance range.

### DETAILED DESCRIPTION

Unless stated to the contrary, implicit from the context, or customary in the art, all parts and percentages are based on weight, all temperatures are in degrees Celsius (° C.), and all test methods are current as of the filing date of this disclosure.

The term “recyclable” or “recyclability” herein, with reference to a first article having a RWAMC, means mechanical recyclable or recyclability; and means the first article with a RWAMC is mechanically re-processable to generate a second article having a desirable performance range, wherein the second article has at least <30% decreased change in performance relative to a the performance of a control article that is without RWAMC and that is reprocessed the same way as the second article. An example of, and not to be limited thereby, testing methods and guidelines for determining recyclability of a plastic article can be found in publication “Benchmark Polyethylene Film and Flexible Packaging Innovation Test Protocol, Film-B-01” (2018) and publication “PE Film Standard Laboratory Processing Practices”, Document Number FPE-P-00 (2020) of The Association of Plastic Recyclers (APR).

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (e.g., greater than [>]50 mole percent [mol %]) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (α) position.

“Polyethylene (PE)” or “ethylene-based polymer” shall mean polymers comprising a majority amount (>50 mol %) of units which have been derived from ethylene monomer. This includes polyethylene homopolymers, ethylene/α-olefin interpolymers, and ethylene/α-olefin copolymers. Common forms of polyethylene known in the art include low density polyethylene (LDPE); linear low density polyethylene (LLDPE); ultra low density polyethylene (ULDPE); very low density polyethylene (VLDPE); medium density polyethylene (MDPE); high density polyethylene (HDPE); enhanced polyethylene; polyethylene elastomers; and polyethylene plastomers. These PE materials are generally known in the art; however, the following descriptions may be helpful in understanding the differences between some of these different PE resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 pounds per square inch (psi) (100 megapascal [MPa]) with the use of free-radical initiators, such as peroxides (see for example U.S. Pat. Nos. 8,916,667; 8,871,887; 8,822,601; 9,228,036; and 9,765,160). LDPE resins typically have a density in the range of 0.916 grams per cubic centimeter (g/cm³) to 0.935 g/cm³.

The term “LLDPE”, includes both resins made using the traditional Ziegler-Natta catalyst systems and chromium-based catalyst systems as well as single-site catalysts, including, but not limited to, bis-metallocene catalysts (sometimes referred to as “m-LLDPE”), constrained geometry catalysts (CGC), and molecular catalysts. Resins include linear, substantially linear, or heterogeneous polyethylene copolymers or homopolymers. LLDPEs contain less long chain branching than LDPEs and includes the substantially linear ethylene polymers which are further defined in U.S. Pat. Nos. 5,272,236; 5,278,272; 5,582,923; and 5,733,155; the homogeneously branched linear ethylene polymer compositions such as those described in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization; or any combination thereof, using any type of reactor or reactor configuration known in the art.

The term “MDPE” refers to polyethylenes having densities of from 0.926 g/cm³ to 0.940 g/cm³ in one general embodiment. “MDPE” is typically made using chromium or Ziegler-Natta catalysts or using single-site catalysts including, but not limited to, bis-metallocene catalysts, constrained geometry catalysts, and molecular catalysts; and typically have a molecular weight distribution (“MWD”) of >2.5.

The term “HDPE” refers to polyethylenes having densities of from >0.940 g/cm³ up to 0.970 g/cm³ in one general embodiment. HDPE is generally prepared with Ziegler-Natta catalysts, chrome catalysts or single-site catalysts including, but not limited to, bis-metallocene catalysts and constrained geometry catalysts.

The term “ULDPE” refers to polyethylenes having densities of from 0.880 g/cm³ to 0.912 g/cm³, in one general embodiment. ULDPE is generally prepared with Ziegler-Natta catalysts, chrome catalysts, or single-site catalysts including, but not limited to, bis-metallocene catalysts and constrained geometry catalysts.

“Polyethylene plastomers/elastomers” are substantially linear, or linear, ethylene/α-olefin copolymers containing homogeneous short-chain branching distributions comprising units derived from ethylene and units derived from at least one C₃-C₁₀ α-olefin comonomer, or at least one C₄-C₈ α-olefin comonomer, or at least one C₆-C₈ α-olefin comonomer. Polyethylene plastomers/elastomers have a density of from greater than or equal to (≥) 0.870 g/cm³ in one embodiment; ≥0.880 g/cm³, in another embodiment; or ≥0.890 g/cm³; in still another embodiment. The density of the polyethylene plastomers/elastomers can be up to 0.900 g/cm³, in one embodiment; 0.902 g/cm³ in another embodiment; 0.904 g/cm³ in still another embodiment; 0.909 g/cm³ in yet another embodiment; 0.910 g/cm³ in even still another embodiment; or 0.917 g/cm³ in even yet another embodiment. In a general embodiment, the density of the polyethylene plastomers/elastomers can be, for example, in the range of from ≥0.870 g/cm³ to 0.917 g/cm³. Nonlimiting examples of polyethylene plastomers/elastomers include AFFINITY™ plastomers and elastomers (available from The Dow Chemical Company), EXACT™ plastomers (available from ExxonMobil Chemical), TAFMER™ elastomers (available from Mitsui Chemicals), NEXLENE™ plastomers (available from SK Chemicals Co.), and LUCENE™ elastomers (available from LG Chem Ltd.); and mixtures thereof.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An objective of the present invention is to produce a first coated article from original components for use in a first application; and then subsequently, after the first coated article is used, the used first coated article can be reprocessed (i.e., the used first coated article can be subjected to a recycling process), as a whole, to form a second article from the reprocessed first coated article directly. The second article can then be used in another subsequent second application.

The coated first article includes a combination of: (a) at least one polyolefin polymer article; and (b) a RWAMC. It has been surprisingly found that the RWAMC coating composition used in the first article has a recyclability property which is imparted to the first coated article; and thus, in some embodiments, the first coated article is recyclable and can be used to produce the second article for various other applications.

In some non-limiting embodiments, the coated first article of the present invention may include, for example, one or more of the following articles: a pellet; a film such as a monolayer film or a multilayer film; a laminate such as a monolayer laminate or a multilayer laminate; a packaging product; and the like. In some non-limiting embodiments, the second article of the present invention, made from the first article, may include, for example, one or more of the following articles: a pellet; a film such as a monolayer film or a multilayer film; a laminate such as a monolayer laminate or a multilayer laminate; a packaging product; and the like.

The polyolefin polymer article, component (a), useful for making the coated first article of the present invention can include an article of one or more polyolefins. The first article can be, for example, a polyolefin film. Generally, the polymeric portion of the film is comprised of at least 80% of a polyolefin polymer in one embodiment, at least 85% of a polyolefin polymer in another embodiment, and at least 90% of a polyolefin polymer in still another embodiment. In one embodiment, the polymeric portion of the film comprises from at least 80% of a polyolefin polymer to 100% of a polyolefin polymer; and in another embodiment, the polymeric portion of the film comprises from at least 80% of a polyolefin polymer to 90% of a polyolefin polymer.

In one preferred embodiment, the polyolefin polymer is at least one PE polymer. For example, the PE polymer, can include one or more of HDPE, LDPE, LLDPE, and mixtures thereof. The polyolefin film may be a monolayer or a multilayer film or may be an oriented film, oriented by machine direction orientation (MDO) or biaxial orientation processes. In another preferred embodiment, the polyolefin is polypropylene (PP), oriented PP (OPP), biaxially oriented PP (BOPP), and mixtures thereof. The non-polyolefin portion of the film may be comprised of polymers such as poly(vinyl alcohol) (EVOH) or a polyamide (e.g., nylon), functionalized tie layer polymers and compatibilizers as described in U.S. Pat. No. 10,300,686.

The RWAMC, component (b), used for making the first coated article of the present invention can include one or more RWAMC that have a recyclability property as defined above. The RWAMC is such that when the first article with the RWAMC is reprocessed (recycled) to make a second article, the second article with the RWAMC exhibits <30% decreased change in performance compared to a control first article without the RWAMC. The second article and the control first article are both reprocessed and tested the same way to determine their respective recyclability properties.

As aforementioned, the present invention can comprise a wide variety of first articles such as films, laminates, and packages, and the like. Therefore, as an illustration only of the present invention and not to be limited thereby, the present invention is described herein with reference to a preferred embodiment which is a monolayer or multilayer film structure, and more particularly, a monolayer film structure. It is, however, understood by one skilled in the art that many other articles can comprise the first article other than a film structure; and that the present invention is not limited thereto.

In some other embodiments, the present invention disclosed herein includes, for example, a monolayer film structure coated with at least one coating layer of the RWAMC; a process for manufacturing the coated monolayer film structure; and a packaging article made from the coated film structure.

In a broad embodiment, the present invention includes a coated film structure having a recyclability property for producing a packaging material that can be recycled at the storefront. The coated film structure includes a combination of at least one substrate web layer such as a polyolefin polymer film coated with a layer of the RWAMC of the present invention. Generally, the recyclable coated film includes: (i) at least a polyolefin polymer in the form of a film layer; and (ii) at least one coating layer of the RWAMC having a recyclability property. The RWAMC is compatible with the polyolefin polymer film layer, wherein the coating layer of the RWAMC is disposed on the outer surface of the film layer for providing a matte coating layer on at least a portion of the surface of the film layer.

For example, in a general embodiment of the present invention includes a monolayer film including: (i) at least a first polyolefin monolayer film web such as a polyethylene (PE) film; and (ii) at least one coating layer of the RWAMC for coating the polyolefin monolayer film web, component (i). One or more other optional second film layer substrates (or film webs) can be added to the above first film structure to produce a multi-layer film structure, if desired.

In some embodiment, the polyolefin film web, component (i), useful for making the matte coated film of the present invention can include a film web made from one or more polyolefins. For example, the polyolefin web, can include a layer of a polyolefin such as HDPE, LDPE, LLDPE, MDO PE, BOPE, and mixtures thereof. In other embodiments, the polyolefin film web can include an oriented PE film made using either machine direction or biaxial orientation processes. And, in still other embodiments, the polyolefin film web can be a PP film web or a BOPP film web.

In yet other embodiments, the polyolefin film web comprises at least 80% of a polyolefin polymer in one embodiment, at least 85% of a polyolefin polymer in another embodiment, and at least 90% of a polyolefin polymer in still another embodiment. In this embodiment, the remaining portion of the film web composition may include non-polyolefin polymers such as EVOH, polyamides, and the like. Other optional layers used in the film structure can include, for example, functional tie layers; and other optional ingredients used in the film web composition can include, for example, compatibilizers as described in U.S. Pat. No. 10,300,686.

The thickness of the polyolefin film web used to form the recyclable coated film of the present invention can be, for example, from 12 microns (μm) to 125 μm in one embodiment, from 20 μm to 100 μm in another embodiment and from 25 μm to 50 μm in still another embodiment.

In a preferred embodiment, the polyolefin film web can comprise, for example, a layer that is a sealant layer having a seal initiation temperature ranging from 75° C. to 100° C.

In one optional embodiment, the coated film structure may comprise a multilayer film structure including a first polyolefin film web and a second polyolefin film web. For example, the film webs of the multilayer film structure can be the same or different so long as the film webs are made of a recyclable material. The multilayer film structure may comprise two or more layers of polyolefins such HDPE, LLDPE and LDPE as described in U.S. Pat. No. 9,421,743. In the above optional embodiment, the second polyolefin film web of the coated multilayer film structure, can include, for example, an EVOH layer, a nylon layer, a metallized layer, and mixtures thereof; wherein the second polyolefin film web is laminated to the first polyolefin film web via any conventional adhesive composition.

The RWAMC useful for making the coating layer, component (ii), of the coated film of the present invention can include, for example, an acrylic-based material cured with a crosslinker such as an isocyanate component. In one preferred embodiment, the RWAMC can include, for example, acrylates, isocyanates, and mixtures thereof. In some embodiments, the acrylic-based material comprises, for example, the following components: (1) a water dispersion which can be made, for example, from emulsion copolymerization of acrylate monomers, the dispersion having a predetermined particle size and distribution of small and large particles such as a portion of small particles having a size of from 0.5 μm to 1.5 μm and a portion of large particles having a size of from 1.5 μm to 7 μm; (2) an acrylic emulsion as binder having a particle size of from 0.05 μm to 1 μm and a glass transition temperature of from 5° C. to 50° C.; and (3) one or more additives such as defoamers, rheology modifiers, wetting agents, slip agents, and the like; and mixtures thereof.

In some embodiments, the acrylic dispersion is made, for example, from copolymerization of methyl methacrylate, ethyl acrylate, butyl acrylate, methacrylic acid, acrylic acid, other vinyl monomers, and the like; and mixtures thereof. And in some embodiments, the acrylic emulsion binder is made, for example, from emulsion polymerization of methyl methacrylate, ethyl acrylate, butyl acrylate, methacrylic acid, acrylic acid, other vinyl monomers, and the like; and mixtures thereof.

In some embodiments, the acrylic polymers of the acrylic dispersion and acrylic emulsion binder, can be made from derivatives of acrylic and methacrylic acids; the group includes also copolymers of acrylic and methacrylic acids with various vinylic and alkylic monomers. In some embodiments, the acrylic-based polymers in the acrylic dispersion and acrylic emulsion may be prepared from polymerization or copolymerization of such monomers as diolefins, e.g., butadiene or isoprene; vinyl aromatic monomers, e.g., styrene; vinyl esters, e.g., vinyl acetate or vinyl benzoate; (meth)acrylate esters, e.g., methyl methacrylate, butyl methacrylate, ethyl acrylate, butyl acrylate, 2-ethylhexyl acrylate, cyclohexane acrylate, alkyl acrylate wherein the alkyl constituent has carbon atoms of <16 carbon atoms, and benzyl acrylate; vinyl chloride; and other monomers polymerizable by free-radical initiation. Other useful acrylic-based materials useful in the present invention are described, for example, in U.S. Patent Application Publication No. US2019/0315994A1.

Besides the RWAMC of the present invention having a recyclability property, the RWAMC has several other beneficial properties compared to other known coating compositions including, for example, good adhesion, anti-glare, thermal or heat seal resistance, abrasion/scratch resistance, color fidelity, and soft touch.

In some embodiments, the RWAMC is used with the film layer, component (i), wherein the film layer is made of a recyclable material such as PE. Once the RWAMC coats the film layer and the coating dries on the film layer as a matte coating layer, a matte coated monolayer film structure is formed. Then, the film structure made from the above layers can advantageously be recycled (without having to separate the layers) after being previously used for its original purpose, viz, the coated film structure has a recyclability property. An article, for example a packaging article, manufactured from the coated film structure containing the RWAMC coating layer, is imparted with an acceptable recyclability property which originated from the coated film structure.

The average thickness of the coating layer of RWAMC used on the film layer to form the coated monolayer recyclable film of the present invention can be, for example, from 1 μm to 5 μm in one general embodiment.

The film structure of the present invention can include other optional substrate layers, component (iii), in addition to the above component layers (i) and (ii). For example, substrates such as EVOH, PVDC, OPA, and mixtures thereof can be laminated (bonded) to the above first film layer via a conventional adhesive, if desired.

In a general embodiment, the recyclable matte coated monolayer film structure of the present invention is produced by the steps of: (1) applying the RWAMC described above onto the surface of the film web substrate to form a coating layer on the surface of the monolayer film web substrate; and (2) drying the RWAMC, or allowing the RWAMC to dry or cure, to provide a coating layer on the film substrate forming a matte coated film. In some embodiments, the process for providing the matte coating on a film substrate of the present invention, includes for example incorporating a crosslinker, such as an isocyanate or a polyisocyanate, into the RWAMC before the RWAMC is applied to a film substrate. Then, the RWAMC and crosslinker is applied to the film web substrate; and the composition is allowed to react to form a coating layer. Thereafter, the coating layer disposed on the substrate is dried, or allowed to dry to complete the matte coated film article.

In the process for providing the matte coated film of the present invention, the application step of the RWAMC can be carried out by conventional means known in the art of applying coating compositions or formulations onto the surface of a film substrate. For example, the RWAMC may be applied to a substrate using gravure or flexographic printing technology, roto gravure lamination equipment with oven drying capabilities; or conventional coatings application methods such as, for example, hand drawdown with a handproofer or a meyer rod, paint brush, paint roller, curtain coater and spraying methods such as, for example, air-atomized spray, air-assisted spray, airless spray, high volume low pressure spray, and air-assisted airless spray.

In the process for providing the matte coated film of the present invention, the drying step of the RWAMC may be allowed to proceed under ambient conditions such as, for example, from 5° C. to 35° C. in one general embodiment; or the coating may be dried at elevated temperatures such as, for example, from 35° C. to 150° C. in one general embodiment.

The web substrates coated with the RWAMC can include, for example, a polyester (e.g., polyethylene terephthalate [“PET”]) films, polyolefin films including pigmented non-pigmented polyethylene and polypropylene and their hybrids, oriented polypropylene (“OPP”) and biaxially-oriented polypropylene (“BOPP”) films, nylon films, paper and paper cardboard, leather, metalized and foil, polyvinyl chloride, woven or nonwoven textiles, ceramic coated polymeric films, printed and nonprinted films.

In one general embodiment, the process for producing a recyclable coated film includes, for example, the steps of:
(I) providing: (i) a polyolefin polymer film web substrate; and (ii) a RWAMC;
(II) applying the RWAMC to at least a portion of the surface of the film substrate to form a coating layer on the film substrate (which may depend on the packaging design selected for implementing the film substrate); and
(III) allowing the structure of step (II) to dry (or cure) for a predetermined time and a predetermined temperature such that a coated film is formed. The drying temperature of step (III) depends on the coating speed utilized and the drying capability of materials employed. As an illustration of the present invention, and not be limited thereby, the drying temperature can be, for example, less than or equal to (≤) 90° C. in one embodiment and ≤85° C. in another embodiment. In still other embodiments, above the drying temperature can be, for example, ≥75° C. in one embodiment and ≥80° C. in another embodiment. In some embodiments, the drying temperature can be from 75° C. to 90° C.

When a second film substrate is used, the first film substrate and the second film substrate can be bonded to each other with an adhesive before the heating step (III). For example, in one general embodiment, the process for producing a coated multilayer film structure includes the steps of:
(I) providing: (i) at least one first polymer film layer; (ii) at least one layer of a RWAMC compatible with the first film layer for coating the first film layer; and (iii) optionally, at least one second polymer film layer; wherein the RWAMC has a recyclability property, wherein the recyclability property of the RWAMC is such that when the article with the RWAMC is reprocessed, the article with the RWAMC exhibits <30% decreased change in performance compared to a control article without the RWAMC when reprocessed the same way as the article with the RWAMC;
(II) optionally, combining the film substrate layer of step (I) with a second film substrate layer with an adhesive layer;
(III) applying the RWAMC from step (I) to at least a portion of the surface of the first film substrate layer of step (I) to form a coating layer of the RWAMC disposed on the surface of the first film layer for coating the first film layer with a matte coating; and
(IV) allowing the coated film structure of step (III) to dry (or cure) to form a matte coated multilayer film.

The optional step of combining the first film substrate layer with a second film substrate layer with an adhesive layer can be carried out prior to the step (III) of applying the RWAMC to the first film as described above, or the optional step of combining the first film substrate layer with a second film substrate layer with an adhesive layer can be carried out after the step of applying the RWAMC to the first film and before the step of allowing the coated film structure to form a matte multilayer coated film. The duration of the drying step is sufficient to form a coated multilayer film structure.

Besides the recyclability of the matte coated film article produced according to the above described process, the resulting recyclable matte coated film article of the present invention may exhibit one or more advantageous properties. For example, the resulting recyclable matte coated film article can include anti-gloss performance, haptic performance, abrasion resistance, and printing color retention, which are typically required performance properties for premium packaging articles to enhance the packaging appearance and shelf differentiation.

The recyclable matte coated film article produced according to the present invention can be used in various applications. For example, the coated film article of the present invention, prior to recycling, can be used in packaging applications for manufacturing various packaging materials and products. For example, the coated film using the RWAMC of the present invention is useful for manufacturing a packaging article for packaging products such as fresh and frozen produce, and general snack packaging. In other embodiments, the film can be used, for example, for bulk packaging of food grains/pulses, packaging of seeds, packaging of lentils and cereals, packaging of fertilizer, packaging of oilseed, packaging of sugar, packaging of salt, packaging of pharmaceuticals, packaging of other food stuff, and personal care items such as bath salts, detergent pods and the like. The film may also be used as a wrapper for baby wipes, feminine hygiene products, cereal bars, protein bars, cheese and confectionary products. Also, other advantageous features and applications for the recyclable coated film when used for packaging articles include, for example, resistance to severe weathering conditions, high tensile strength, robust drop test resistance, and excellent optical matte appearance.

One of the advantages of the present invention is that a used virgin article (first article) made from the coated film of the present invention can be processed through a recycling process. After recycling, the recycled material from the previous virgin article can be used to make a subsequent recycled film, and in turn a recycled article (second article), with properties and performances very close to the previous virgin article. For example, a new monolayer film structure made with recycled material from the recycled article (second article) can have properties that exhibits <30% decreased change in performance relative to a control film that is reprocessed the same without a coating added. In some embodiments, the new monolayer film structure can have properties that exhibits a decreased change in performance at <30% in one embodiment, <25% in another embodiment, and <10% in still another embodiment. In some embodiments, the new monolayer film structure can have properties that exhibits a decreased change in performance in the range of from 0% to <30% in one embodiment, 0.01% to <30% in another embodiment, and from 0.1% to <30% in still another embodiment. In some embodiments, the new monolayer film structure can have properties that exhibits a decreased change in performance in the range of from 0% to <25% in one embodiment, 0.01% to <25% in another embodiment, and from 0.1% to <25% in still another embodiment. In some embodiments, the new monolayer film structure can have properties that exhibits a decreased change in performance in the range of from 0% to <10% in one embodiment, 0.01% to <10% in another embodiment, and from 0.1% to <10% in still another embodiment.

In a general embodiment, the process for producing a reprocessed second article from, for example, a first packaging article (i.e., the virgin article) comprises the steps of:
(A) providing a first packaging article made from the film of the present invention;
(B) fragmenting the packaging article from step (A) to produce a plurality of fragments of a predetermined size;
(C) pelletizing the plurality of fragments from step (B) to form a plurality of pellets of a predetermined size; and
(D) processing the pellets from step (C) to form a reprocessed second article.

In some embodiments, a third article can be produced from the reprocessed second article made by the above general process. For example, the third article can be selected from the group consisting of: pellets, monolayer or multilayer films, multilayer laminates, and packaging materials or products.

### Examples

The following examples are presented to further illustrate the present invention in detail but are not to be construed as limiting the scope of the claims. Unless otherwise indicated, all parts and percentages are by weight.

Various materials used in the Inventive Examples (Inv. Ex.) and the Comparative Examples (Comp. Ex.), which follow, are described in Table I.

TABLE I
Raw Materials

| Material | Brief Description | Supplier |
|---|---|---|
| ELITE ™ 5960G1 | HDPE having a melt index of 0.85 decagrams per | The Dow Chemical |
| | minute (dg/min) and a density of 0.962 grams per | Company (Dow) |
| | cubic centimeter (g/cc) | |
| UNIVAL ™ DMDA 6400 | HDPE having a melt index of 0.8 dg/min and a | Dow |
| | density of 0.961 g/cc | |
| AFFINITY ™ PL 1850G | Ultra linear low density polyethylene (ULLDPE) | Dow |
| | (plastomer) having a melt index of 3 dg/min and a | |
| | density of 0.902 g/cc | |
| DOW ™ CR 9-101 | Isocyanate curative | Dow |
| INNATE ™ ST50 | LLDPE having a melt index of 0.85 dg/min and a | Dow |
| | density of 0.918 g/cc | |
| DOWLEX ™ GM 8070G | LLDPE having a melt index of 0.90 dg/min and a | Dow |
| | density of 0.917 g/cc | |
| AGILITY ™ 1021 | LDPE having a melt index of 1.85 dg/min and a | Dow |
| | density of 0.920 g/cc | |
| AB MB AMPACET ™ 10063 | Antiblock masterbatch having a melt index of | Ampacet |
| | 1 dg/min and a density of 1.050 g/cc | Corporation |
| Slip MB AMPACET ™ 10090 | Erucamide masterbatch having a melt index of | Ampacet |
| | 1 dg/min and a density of 0.916 g/cc | Corporation |
| OPULUX ™ HGT 3020/3021 | Polyurethane-based coating | Dow |
| OPULUX ™ MATTE 5003MC | Acrylic-based coating | Dow |

### Film Formation

Table II describes the compositions of the PE films prepared herein for testing including the composition for a control film, a glossy coated film, and a matte coated film.

TABLE II
Composition/Structure of PE Films

| | | Glossy | Matte |
|---|---|---|---|
| | Con- | Coating | Coating |
| Ingredient | trol (%) | 1.5 gsm (%) | 1.5 gsm (%) |
| ELITE ™ 5960GI | 61 | 61 | — |
| UNIVAL ™ DMDA 6400 | — | — | 61 |
| AFFINITY ™ PL 1850G | 16 | 16 | 16 |
| INNATE ™ ST50 | 15 | — | 15 |
| DOWLEX ™ 8070G | — | 15 | — |
| AGILITY ™ 1021 | 7 | 7 | 7 |
| AB MB AMPACET ™ 10063 | 1 | 1 | 1 |
| Slip MB AMPACET ™ 10090 | 0.5 | 0.5 | 0.5 |

### General Procedure for Coating a Film

A PE film is coated with a coating composition to form a coating layer on the PE film using a Super-Combi 3000 series laminator (available from Nordmeccanica). The laminator has a maximum film width of 1,320 millimeters (mm) and a minimum film width of 600 mm. Additionally, the laminator contains 2 modular coating decks: (1) a waterborne deck for waterborne lamination and (2) a Gravure deck for water-based and solvent-based adhesives/coatings. Additionally, the laminator contains 2 modular coating decks: (1) a solventless deck for solventless lamination and (2) a Gravure deck for water-based and solvent-based adhesives/coatings. The laminator also contains 2 zone forced air dryers and a 7.5 kilowatt (KW) corona treater (available from Enercon Industries Corporation) for both a primary film and a secondary film. The maximum line speed of the laminator is 400 meters per minute (m/min) (or 1,312 feet per minute). All unwinds use a 76 mm or a 152 mm core and rewinds use only a 152-mm core. The laminator is capable of running most packing films such as a polyester, oriented polypropylene, polyethylene, nylon, paper, foil (secondary only) and others.

For the purposes of the present invention, the waterborne coating used in the Inv. Ex. was a RWAMC, such as OPULUX™ 5003MC/DOW™ CR 9-101 at a mix ratio of from 100:0.5 to 100:1.0 in one general embodiment; and was run on the laminator coating unit with a target coating weight of 1.0 lbs./ream (1.6 gsm) utilizing the Gravure deck. Upon completion of coating the films, the rolls of film were allowed to fully cure at ambient temperature (about 25° C.) for 7 days.

### General Procedure for Film Reprocessing

The publication “Association of Plastics Recyclers FPE-CG-01 Critical Guidance Protocol for PE Film and Flexible Recycling” published by the Association of Plastics Recyclers (APR) was used as a guide for assessing re-processability of the films produced and tested in the Examples. The above protocol calls for evaluating the re-processability of an innovative or test film by comparing the test film to a control film which is similar to the test film except that the control film lacks the component or feature that makes the test film innovative. The protocol calls for both films, the control film and the test film, to undergo the following simulated reprocessing, viz, recycling process.

The test films and control films are first individually shredded and densified. Then, the densified material is fed into a pelletizing extruder. Next, the reprocessed pellets from the pelletizing extruder are used to make a melt blend of 50% control pellets and 50% test pellets via a compounding extruder. In addition, a batch consisting of 100% control pellets and another batch consisting of 100% test pellets are also processed through the compounding extruder to provide the same heat history as the batch of 50/50 blend pellets. The pellets from the compounding extruder is then used to blow films for characterization. The film blow up ratio (BUR) is targeted at 2.5. The films are characterized for haze, instrumented drop dart and tear in the machine direction (MD) and the cross direction (CD). The test film is considered re-processable if the mechanical properties of the 50/50 film blend does not decrease by more than 30% as compared to the reprocessed control film.

### General Procedure for Film Shredding/Pelletizing

Shredding and pelletizing of films are accomplished using known standard equipment and procedures. For the films disclosed herein, a pelletizer, INTAREMA® 605 K pelletizer unit (available from EREMA), is used. The barrel zone of the pelletizer is run at 171° C.; and the pelletizer zone is run at 176° C.

### General Procedure for Compounding Blend Ratios

The pellets produced using the above pelletizer are compounded utilizing known standard equipment and procedures. For the films disclosed herein, a twin screw extruder, LabTech 26 mm Twin-Screw Extruder, Type LTE26-44 (Part II) (available from LabTech Engineering Company, LTD), is used. The run parameters of the above extruder are described in Table III.

TABLE III
Extruder Parameters

| | Sample ID: | | | | | | | | |
|---|---|---|---|---|---|---|---|---|---|
| | | | | | | | Extruder | Melt | Melt |
| | Zone 1 | Zone 2 | Zone 3 | Die Zone | Chiller Temp. | Rate | Speed | Pressure | Temperature |
| | Units: | | | | | | | | |
| | ° C. | ° C. | ° C. | ° C. | ° C. | 454 g/hr | rpms | ×10⁶ Pa | ° C. |
| Setpoint: | 177 | 204 | 218 | 221 | 17.8 | 6.5-7.5 | 55-65 | 17.2-19.3 | 190.6-196.1 |

### Film Testing

The films prepared in the Examples were tested for the following physical properties: Dart, Tear, Secant Modulus and Tensile. The tests were conducted as described in the following ASTM test methods: ASTM D1709 was used to measure Drop Dart; ASTM D1922 was used to measure Elmendorf Tear; ASTM D882 was used to measure Secant Modulus; ASTM D822 was used to measure Tensile; and ASTM D1003 was used to measure Haze.

### Test Results

The results of the above film testing are described in Table IV below.

The reprocessed control film (Comp. Ex. A) is a non-coated PE film.

The films prepared in Inv. Ex. 1 and Inv. Ex. 2 were produced as follows:

A PE film was coated with a RWAMC, OPULUX™ 5003 MC. Then the matte coated PE film was shredded and pelletized. The resulting pellets made from the shredded film were either: (1) used alone without blending with control PE pellets (Inv. Ex. 1); or (2) blended at a 1:1 ratio with control PE pellets (Inv. Ex. 2).

The films prepared in Comp. Ex. B and C were produced as follows:

A PE film was coated with a glossy (i.e. non-matte) polyurethane (PU) coating composition, OPULUX™ 3020/3021. Then the glossy coated PE film was shredded and pelletized. The resulting pellets were either: (1) used alone without blending with control PE pellets (Comp. Ex. B); or (2) blended at a 1:1 ratio with control PE pellets (Comp. Ex. C).

None of the resulting coated PE films of the present invention can have more than a 25% drop (i.e., a decreased change) in physical properties compared to the uncoated control sample film as described in Table IV A and IV B. The property of “Haze” is described in Table IV for illustrative purposes and is not measured as one of the physical properties of the coated PE films of the present invention for purposes of having less than a 25% decreased change.

TABLE IV A
Properties of Films

| Example | Brief Description of | Thickness | Haze | | Dart | | MD Tear | | TD Tear | |
|---|---|---|---|---|---|---|---|---|---|---|
| No. | Coating on Film | (μm) | (%) | (% Δ) | (J) | (% Δ) | (g) | (% Δ) | (g) | (% Δ) |
| Comp. Ex. A | Control (no coating) | 50.7 | 18.28 | — | 0.191 | — | 146 | | 887 | — |
| Inv. Ex. 1 | 100% Matte Coating | 54.6 | 35.65 | 95 | 0.151 | −20.9 | 99 | −32.2 | 1,129 | 27.3 |
| | (OPULUX ™ 5003 MC) | | | | | | | | | |
| Inv. Ex. 2 | 50/50 Control/Matte | 55.2 | 29.06 | 59 | 0.203 | 6.3 | 128 | −12.3 | 999 | 12.6 |
| | Coating | | | | | | | | | |
| Comp. Ex. B | 100% PU Coating | 93.7 | 67.88 | 271 | 0.044 | −77.0 | 108 | −26.0 | 195 | −78.0 |
| | (OPULUX ™ 3020/3021) | | | | | | | | | |
| Comp. Ex. C | 50/50 Control/PU | 84.2 | 47.82 | 162 | 0.073 | −61.8 | 122 | −16.4 | 484 | −45.4 |
| | Coating | | | | | | | | | |

TABLE IV B

| Brief | | | % | | % | | % | | % |
|---|---|---|---|---|---|---|---|---|---|
| Description | | Tensile | Delta | Tensile | Delta | Secant | Delta | Secant | Delta |
| of Coating on | Thickness | MD | Tensile | TD | Tensile | MD | Secant | TD | Secant |
| Film | (μm) | (PSI) | MD | (PSI) | TD | (PSI) | MD | (PSI) | TD |
| Control (no | 50.7 | 3798.6 | | 3412.8 | | 85534.9 | | 90297.2 | |
| coating) | | | | | | | | | |
| 100% Matte | 54.6 | 3781.3 | −0.5 | 2946.7 | −13.7 | 75115.3 | −12.2 | 88352.9 | −2.2 |
| Coating | | | | | | | | | |
| (OPULUX ™ | | | | | | | | | |
| 5003 MC) | | | | | | | | | |
| 50/50 | 55.2 | 3893.4 | 2.5 | 3131 | −8.3 | 80319.8 | −6.1 | 91100.8 | 0.9 |
| Control/Matte | | | | | | | | | |
| Coating | | | | | | | | | |
| 100% PU | 93.7 | 1530.4 | −59.7 | 1307.1 | −61.7 | 44081.9 | −48.5 | 47355.6 | −47.6 |
| Coating | | | | | | | | | |
| (OPULUX ™ | | | | | | | | | |
| 3020/3021) | | | | | | | | | |
| 50/50 | 84.2 | 2254.2 | −40.7 | 1814 | −46.8 | 48081.5 | −43.8 | 54355.1 | −39.8 |
| Control/PU | | | | | | | | | |
| Coating | | | | | | | | | |

The PE films described in Table V and Table VI were tested for heat resistance. Each of the coated PE films had a coating of about 1.0 lbs/ream (1.6 gsm); and the PE films used in the tests were recycle ready films 0.088 mm thick.

The temperature resistance property of the matte coating, OPULUX™ 5003-MC, disposed on a PE film was evaluated by exposing the coated PE film under a heat-sealing bar of a heat-sealer at various sealing temperatures and durations. The heat-sealer had a bottom bar and a top bar. The resultant exposed (sealed) PE film is evaluated for seal strength and stickiness to the heat-sealing bar of the heat-sealer as a measure of heat resistance.

The PE films described in Table V and Table VI were tested for heat resistance. The films described in Table V were tested using a heat-sealer wherein the bottom heat-sealing bar of the heat-sealer was not heated and a Teflon sheet was not placed over the bottom bar. The films described in Table VI were tested using a heat-sealer wherein the bottom heat-sealing bar of the heat sealer was not heated and a Teflon sheet was placed over the bottom bar.

After the duration of heat applied to a film sample, the stickiness of the film sample to the heat-sealing bar was observed and visually rated with a numerical ranking from “1” to “4”. A ranking of “4” means the film sample exhibited good heat resistance; and a ranking of “1” means the film sample exhibited a poor heat resistance. The numerical ranking results of heat sealing the film samples described in Table V and Table VI are as follows: a “4” indicates the film sample tested exhibited a “good seal”; a “3” indicates the film sample exhibited a “weak seal” or “no seal”; a “2” indicates the film sample exhibited a “slight sticking to the top bar”; and a “1” indicates that the film sample “melted” or the film “stuck to the bar”.

TABLE V
Heat Seal-Heat Resistance of Matte Coated PE Film (Without Teflon Sheet)

| | Heating Duration: | | | | | |
|---|---|---|---|---|---|---|
| | 0.5 second | | | 1 second | | |
| | Sample Tested: | | | | | |
| | | | Printed; Coated with | | | Printed; Coated with |
| | Unprinted; | Printed; | OPULUX ™ 5003 MC | Unprinted; | Printed; | OPULUX ™ 5003 MC |
| Temperature (at | Uncoated | Uncoated | (1.66 gsm) | Uncoated | Uncoated | (1.66 gsm) |
| 0.28 × 10⁶ Pa) | Ranking of Heat Resistance | | | | | |
| 93.3° C. | 4 | 4 | 3 | 4 | 4 | 4 |
| 104.4° C. | 4 | 2 | 4 | 4 | 2 | 4 |
| 115.6° C. | 4 | 1 | 4 | 2 | 1 | 2 |
| 126.7° C. | 1 | 1 | 4 | 1 | 1 | 2 |
| 137.8° C. | 1 | 1 | 2 | 1 | 1 | 2 |
| 148.9° C. | 1 | 1 | 1 | 1 | 1 | 1 |

TABLE VI
Heat Seal-Heat Resistance of Matte Coated PE Film (With Teflon Sheet)

| | Heating Duration: | | | | | |
|---|---|---|---|---|---|---|
| | 0.5 second | | | 1 second | | |
| | Sample Tested: | | | | | |
| | | | Printed; Coated with | | | Printed; Coated with |
| | Unprinted; | Printed; | OPULUX ™ 5003 MC | Unprinted; | Printed; | OPULUX ™ 5003 MC |
| Temperature | Uncoated | Uncoated | (1.66 gsm) | Uncoated | Uncoated | (1.66 gsm) |
| (at 0.28 × 10⁶ Pa) | Ranking of Heat Resistance | | | | | |
| 93.3° C. | 3 | 3 | 3 | 3 | 3 | 3 |
| 104.4° C. | 3 | 3 | 3 | 4 | 4 | 4 |
| 115.6° C. | 4 | 4 | 3 | 4 | 4 | 4 |
| 126.7° C. | 4 | 3 | 4 | 2 | 1 | 4 |
| 137.8° C. | 1 | 1 | 4 | 1 | 1 | 1 |
| 148.9° C. | 1 | 1 | 2 | 1 | 1 | 1 |

What is claimed is:

1. A coated article coated with a coating composition having recyclability properties comprising a combination of:
(a) at least one polyolefin polymer article; and
(b) at least one coating layer of a waterborne acrylic-based matte coating composition coated on the polyolefin polymer article; wherein the coating composition has a recyclability property; wherein the recyclability property of the waterborne acrylic-based matte coating composition is such that when the article coated with the waterborne acrylic-based matte coating composition is reprocessed, the article coated with the waterborne acrylic-based matte coating composition exhibits less than a 30 percent decreased change in performance compared to a control article without the waterborne acrylic-based matte coating composition when the control article is reprocessed the same way as the article coated with the waterborne acrylic-based matte coating composition.

2. The coated article of claim 1, wherein the polyolefin polymer of the at least one polyolefin polymer article is polyethylene.

3. The coated article of claim 1, wherein the waterborne acrylic-based matte coating composition comprises:
(α) a formulation of:
(αi) an acrylic dispersion having a predetermined particle size and a predetermined particle distribution; and
(αii) an acrylic emulsion binder having a predetermined particle size and a predetermined glass transition temperature;
(β) a water dispersible polyisocyanate crosslinker.

4. The coated article of claim 3, wherein the formulation (α) further includes (αiii) one or more additives selected from the group consisting of defoamers, rheology modifiers, wetting agents, slip agents, and mixtures thereof.

5. The coated article of claim 1, wherein the at least one polyolefin polymer article is a first article selected from the group consisting of a monolayer film, a multilayer film, a monolayer laminate, a multilayer laminate, and a packaging material, and a molded product.

6. A second article made from any one of the first articles of claim 5.

7. The second article of claim 6, wherein the second article is selected from the group consisting of pellets, a monolayer film, a multilayer film, a monolayer laminate, a multilayer laminate, a packaging material, and a molded product.

8. A process for producing a coated article with a coating composition having a recyclability property comprising applying a waterborne acrylic-based matte coating composition having a recyclability property to the surface of an article made of at least one polyolefin polymer; wherein the recyclability property of the waterborne acrylic-based matte coating composition is such that when the article coated with the waterborne acrylic-based matte coating composition is reprocessed, the article coated with the waterborne acrylic-based matte coating composition exhibits less than a 30 percent decreased change in performance compared to a control article without the waterborne acrylic-based matte coating composition when the control article is reprocessed the same way as the article coated with the waterborne acrylic-based matte coating composition.

9. A coated film structure coated with a coating composition having a recyclability property comprising:
(i) at least one film layer of at least one polyolefin polymer; and
(ii) at least one layer of a waterborne acrylic-based matte coating composition having a recyclability property; wherein the recyclability property of the waterborne acrylic-based matte coating composition is such that when the article coated with the waterborne acrylic-based matte coating composition is reprocessed, the article coated with the waterborne acrylic-based matte coating composition exhibits less than a 30 percent decreased change in performance compared to a control article without the waterborne acrylic-based matte coating composition when the control article is reprocessed the same way as the article coated with the waterborne acrylic-based matte coating composition; wherein the waterborne acrylic-based matte coating composition is compatible with the film layer; and wherein the waterborne acrylic-based matte coating composition is disposed on at least a portion of the surface of the film layer.

10. A process for producing a coated film structure comprising the steps of:
(I) providing: (i) at least one film layer of at least one polyolefin polymer; and (ii) at least one layer of a waterborne acrylic-based matte coating composition having a recyclability property; wherein the waterborne acrylic-based matte coating composition is compatible with the film layer; wherein the recyclability property of the waterborne acrylic-based matte coating composition is such that when the film layer coated with the waterborne acrylic-based matte coating composition is reprocessed, the article coated with the waterborne acrylic-based matte coating composition exhibits less than a 30 percent decreased change in performance compared to a control article without the waterborne acrylic-based matte coating composition when the control article is reprocessed the same way as the article coated with the waterborne acrylic-based matte coating composition;
(II) applying the waterborne acrylic-based matte coating composition from step (I) to at least a portion of the surface of the at least one film layer of step (I) to form a coating layer of the waterborne acrylic-based matte coating composition disposed on the surface of the film layer; and
(III) allowing the waterborne acrylic-based matte coating composition to dry on the surface of the film layer of step (II) to form a matte coated film structure.

11. A packaging article made from the coated film structure of claim 10.

12. A process for producing a reprocessed second article from the packaging article of claim 11 comprising the steps of:
(A) providing a packaging article of claim 11;
(B) fragmenting the packaging article from step (A) to produce a plurality of fragments of a predetermined size;
(C) pelletizing the plurality of fragments from step (B) to form a plurality of pellets of a predetermined size; and
(D) processing the pellets from step (C) to form a reprocessed second article.

13. A third article produced from the reprocessed second article made by the process of claim 12.

14. The third article of claim 13, wherein the third article is selected from the group consisting of: pellets, a monolayer film, a multilayer film, a monolayer laminate, a multilayer laminate, a packaging material, and a molded product.
